(19) United States
(12) Patent Application Publication
(10) Pub. No.: US 2009/0217901 A1
(43) Pub. Date: Sep. 3, 2009

(54) Driving Mechanism of a Crankless Engine

(76) Inventor: Xueyu Zuo, Heilongjiang Province (CN)

Correspondence Address: BROMBERG & SUNSTEIN LLP, 125 SUMMER STREET, BOSTON, MA, 02110-1618, US

(21) Appl. No.: 12/280,617

(22) PCT Filed: Feb. 7, 2007
(86) PCT No.: PCT/CN2007/000428

§ 371 Date: May 7, 2009

(30) Foreign Application Priority Data
Feb. 27, 2006 (CN) 200610067524.8

(51) Int. Cl. F02B 75/32

(52) U.S. Cl. 123/197.1

(57) ABSTRACT

The application relates to a driving mechanism which is comprised of a toggle rod and a ratchet wheel (61), the toggle rod is comprised of a linkage (4) and a big arm (24) of a sliding bush (14), and the driving mechanism converts reciprocating motion to rotary motion. Four parallel cylinders (2) are disposed in a cylinder block (1), a main shaft (25) is placed between the cylinders (2), and the axis of the main shaft is perpendicular to the axis of cylinders. There are two big arms (24) and two small arms (34) on the sliding bush (14). The linkage (4) is connected to the big arm (24) by a pin. Pistons (3) are reciprocated, and the big arms (24) are swayed by the linkage (4). The small arm (34) has forward and reverse detents (29). The mechanism is used in engines and other transmission mechanisms.

### TECHNICAL FIELD

This patent involves a driving mechanism composed of toggle rod and ratchet, applied to a crankless engine or other machines. The related technical field is mechanical driving.

### BACKGROUND TECHNOLOGIES

The patent (THE ENGINE WITH RACK, GEAR, RATCHET AND ELECTRIC CONTROL VALVE) with China application number 200510091222.X, and international application number PCT/CN2005/001968 involves a crankless engine, driven by rack, gear and ratchet, and the valve electrically controlled by computer. Its disadvantage is that, due to the limitation of the processing precision, there would be gap between the rack and the gear, which generates vibration while the meshed rack and gear move reciprocally at high speed.

### CONTENT OF PATENT

The goal of this patent is to invent a driving mechanism with toggle-rod and ratchet, applied to crankless engines, to replace the mentioned engine above driven by rack, gear and ratchet. This patent can efficiently reduce the engine vibration and make the crankless engine finally possible.

The solution to solve the foregoing problems in this patent is as followed.

At least four cylinders of parallel axes are set in the engine cylinder body. Cylinders are disposed horizontally and divided into two groups, the upper group and the lower group. The axes of the two cylinders in each group are parallel to each other and have a distance between. A main shaft with sliding bush is set between these two groups of cylinders and the axis of the main shaft is perpendicular to, but does not intersect, the axes of the cylinders. On the sliding bush there are two big arms and two small arms and they are set symmetrically with an angular distance. On the big arms there is a slot parallel to the cylinder axis as well as a pin hole parallel to the main shaft axis. The bigger ends of the two linkages are set in the slots on the big arm and are fixed to the big arm with pins. The smaller ends of the two linkages are fixed to the two pistons, respectively. The pin shaft of the swaying arm on top of the main shaft has a central hole. On either side of the small arm there is a detent. These two detents, fixed by pin shafts, have opposite directions. They are meshed with the ratchet wheel on the main shaft, and with the ratchet wheel turning conjugated with the main shaft, respectively. A small hole in the direction perpendicular to the pin shaft is drilled on the pin shaft of the fixed detent. A steel spring is tightly inserted into this hole as well as fixed to the pin shaft. Its swing end is pressed to the pin, which is fixed to the detent. And it is to keep the detent tight to the ratchet gear. The ratchet gear, turning conjugated with the main shaft, is combined with a small gear and named as the gear-ratchet module. This gear is meshed with the intermediate gear mounted on the swing arm shaft of the bearing block of the cylinder body. And the intermediate gear is further meshed with the small gear fixed on the transmission shaft, which is parallel to the main shaft axis. These three gears have same modulus. The pitch circle radius of the gear in the gear-ratchet module is equal to that of the small gear on the transmission shaft. On the other end of the transmission shaft a big gear is fixed. Its pitch circle radius and modulus are the same as the big gear fixed on the main shaft and it is directly meshed with the big gear. When the pistons above the main shaft move from right to left, a piston pushes the sliding bush rotate anti-clockwise with the help of the linkage. One pair of detents on the sliding bush is meshed with the ratchet fixed on the main shaft and makes the main shaft rotate anti-clockwise. The other pair of detents races rotation against the ratchet of the gear-ratchet module. Meanwhile, the sliding bush pushes the linkage and pistons under the main shaft move from left to right, with the help of the pin shaft on the other big arm. Vice versa, when the pistons above the main shaft move from left to right, a piston pushes the sliding bush rotate clockwise with the help of the linkage. One pair of detents on the sliding bush is meshed with the ratchet in the gear-ratchet module and they make the small gear thereby rotate clockwise. They make the big gear fixed on the main shaft rotate anti-clockwise, with the help of the intermediate gear, and the small gear and the big gear on the transmission shaft. Meanwhile, the big arm at the other end of the sliding bush makes the linkage and pistons under the main shaft move from right to left. Beneath the coping of the cylinder body and on either side of the linkage and the sliding bush there is a fixed plate. When the piston is at its left and right stop points, at the positions corresponding to the central hole on the pin shaft of the linkage on the sliding bush, two small holes are drilled and photoelectric sensor is set into each hole on the fixed plate. When the left piston above the main shaft is at its left stop point, the central hole on the pin shaft of the sway arm is exactly coaxial to the connection line of the two photoelectric cells of the left group of photoelectric sensor. Then, the light of the emitting cell is received by the receiving cell, converted into electrical signal and sent to the concentrative electronic controller. The concentrative electronic controller processes this signal as well as signals from other sensors and identifies that the piston state is at the end of the compression, so lets the fuel injector to inject and the spark plug to ignite of this cylinder. Thereafter this cylinder starts the combustion stroke. Meanwhile, the concentrative electronic controller sends on or off instructions to valves of other cylinders according to predefined program. When the right piston above the main shaft is at its right stop point, the central hole on the pin shaft of the sway arm is exactly coaxial to the connection line of the two photoelectric cells of the right group of photoelectric sensor. Then, the light of the emitting cell is received by the receiving cell, converted into electrical signal and sent to the concentrative electronic controller. The concentrative electronic controller processes this signal as well as signals from other sensors and identifies that the piston state is at the end of the compression, so lets the fuel injector to inject and the spark plug to ignite of this cylinder. Thereafter this cylinder starts the combustion stroke. Meanwhile, the concentrative electronic controller sends on or off instructions to valves of other cylinders according to predefined program. The strokes are the same as in the patent with China patent application number 200510091222.X. The bearings of rotary components in this driving mechanism of the linkage and the ratchet are all sliding bearings, which is the same as the conventional engine. For the engines with lower rotation speed of the main shaft, the ratchet gear mechanism can be replaced by a unidirectional overrunning clutch.

This patent uses toggle rod, which is comprised of linkage and big arm on the sliding bush, as the driving mechanism to transform the reciprocating motion of the pistons into the reciprocating sway of the sliding bush, and further into rotation of the main shaft through ratchet gear mechanism. The maximum deviation between the linkage force direction and the tangent of the circle, whose radius is the length of the big arm on the sliding bush, is no more than 1 grade angular. This means that the most portion of the piston force is converted into the torque on the main shaft, unlike the conventional engines, in which a part of piston force is exerted on the crank shaft and bends it. Especially in the initial phase of the combustion stroke, the normal force is larger than the tangential one, where a majority of the work is converted into destructive energy to bend the crank shaft. Therefore, the engine in this patent has much higher mechanical efficiency than the conventional ones. Theoretical analysis shows that, compared with the conventional engines, provided the same cylinder displacement, this patent can increase the power by about 50% and decrease the fuel consumption by about 30%. The force exerted on the piston in the side direction is less, hence abrasion on the piston and the cylinder is less, and life is longer. All the rotary components in this patent are supported by sliding bearings, with larger pressure area and the oil membrane, hence the rotary components have better cushion under the reciprocating force and, less vibration. The two groups of pistons move in opposite directions and their reciprocating inertia forces counteract each other, hence there is no reciprocating inertia force in this patent. Reciprocating inertia force causes engine vibration. Such force in conventional engines is relatively large and difficult to be balanced. However in this patent both the main shaft structure and the sliding bush structure are symmetric, so they both do not produce centrifugal inertia force during rotating. The centrifugal inertia force produces vibration for the engine and abrasion for the main shaft neck, hence the engine in this patent has almost no vibration at operation and the life of the main shaft as well as the bearing is much longer than conventional engines.

The main shaft rotates about ⅙ loop for one piston in this patent to complete a working stroke and thus, ⅔ loop for all the four pistons. However in the conventional engine, the crank shaft rotates ½ loop for one piston to complete a working stroke and thus, 2 loops for all the four pistons. Therefore, rotation speed ratio of the engine in this patent to the conventional engine is 1:3, provided the same power output, i.e. same piston diameters, same stroke length. So the motion elements have less abrasion because the invented engine has lower rotation speed. And this also extends the engine life. Another benefit from the lower gear reduction ratio of the gear box is a simplified structure for the entire engine. For every rotate of the engine in this patent, the piston's working frequency is 3 times as the conventional one. The output torque is there for larger and smoother. The piston has no dead points, hence the conventional flywheel can be deleted. The balancing weight for the crank as in conventional engines can also be canceled. These two benefits reduce the weight of the engine as well as the total cost.

In summary, this new engine is suitable for cars more comfortable.

### DRAWINGS ILLUSTRATION

The detailed structure of this patent is presented by the following instantiation and drawings.

FIG. 1 is the cutaway view of the cylinder body of the driving mechanism of a crankless engine in this patent.

FIG. 2 is the M-A-B-C-N cutaway view in FIG. 1.

FIG. 3 is the B-J-C cutaway view in FIG. 1.

FIG. 4 is the K-K cutaway view in FIG. 2.

FIG. 5 is the S-S cutaway view in FIG. 1.

FIG. 6 is the cutaway view of the sliding bush with its relating components, after the ratchet wheel is replaced by the non-return stopper.

### IMPLEMENTATION DETAILS

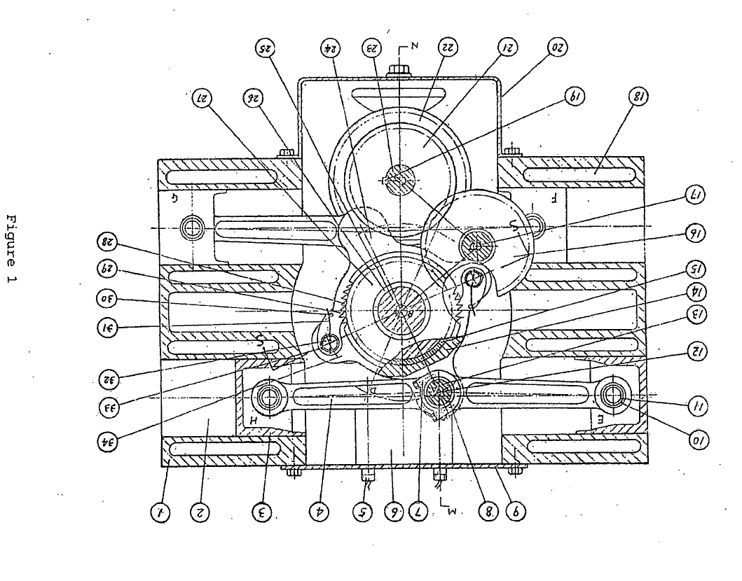

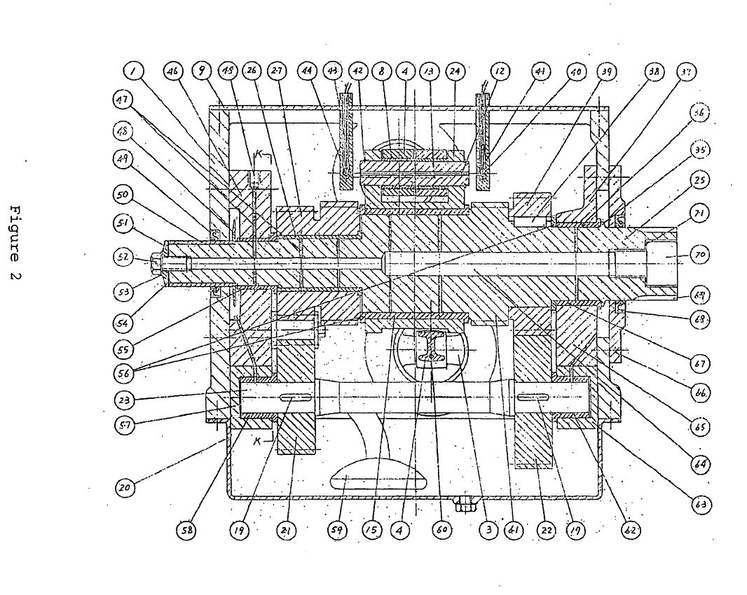

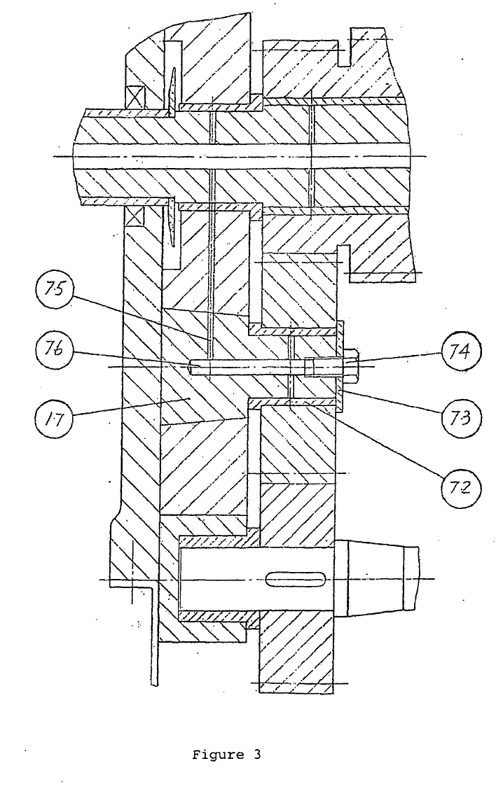

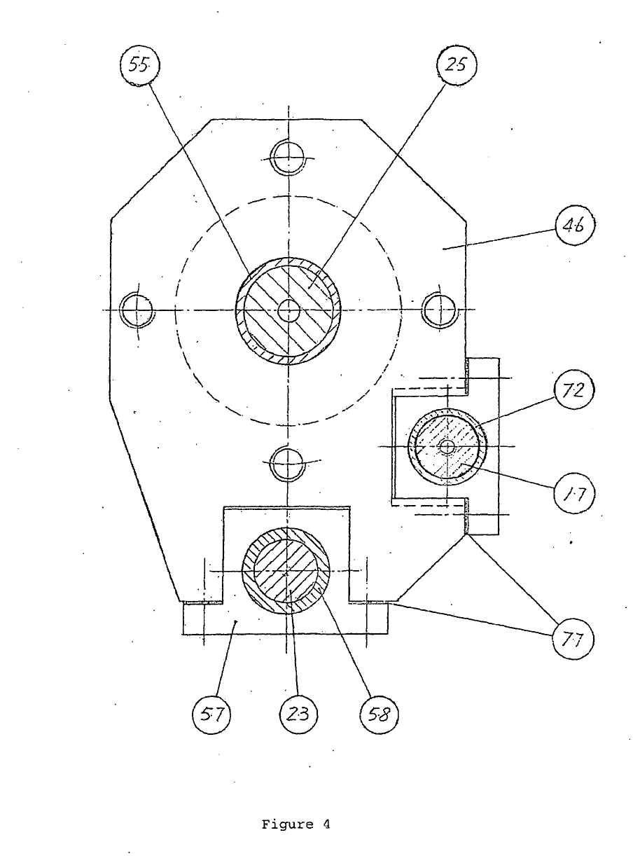

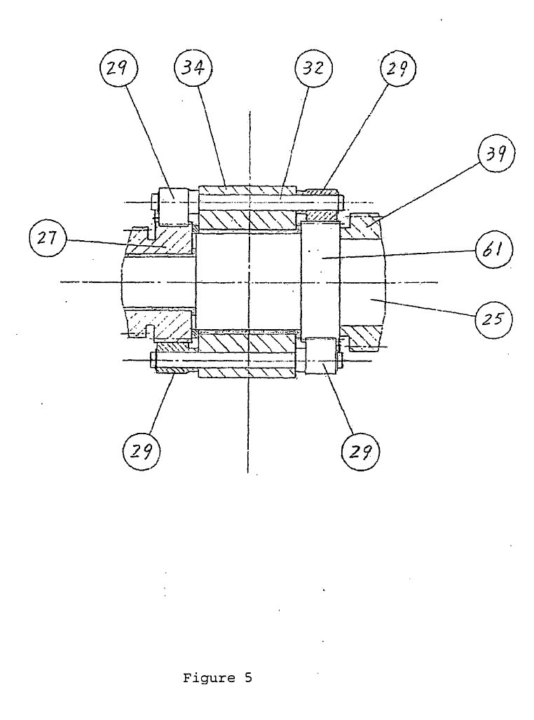

Detailed operation of the engine in this patent will be discussed as following, referred to FIG. 1 to 6. However, this is not a restriction upon the patent.

This patent consists of cylinder body 1, cylinder 2, piston 3, connecting rod 4, main shaft 25, sliding bush 14, ratchet wheel 61 (combined together with the main shaft), gear-ratchet module 27 (turning conjugated with the main shaft), pin shaft 13 (fixed to the big arm 24 on the sliding bush), pin shaft 32 (fixed to the small arm 34 on the sliding bush), detents 29 (installed onto the pin shafts), swing arm shaft 17 (fixed to the bearing block 46 on the cylinder body), intermediate gear 16 (turning conjugated with the swing arm shaft), small gear 21 and big gear 22 (fixed to the transmission shaft 23), big gear 39 (fixed to the main shaft), and the photoelectric sensor composed of emitting photoelectric cell 40 and receiving photoelectric cell 44.

Cylinder body 1 is molded with cast iron or aluminum alloy, inside which at least four cylinders 2 of parallel axes are made. They are disposed in pairs, with certain distance between. The distance is equal to the length between the central lines of the two connecting rods, when the big ends of the two rods are installed in line onto the pin shaft 13 of the big arm on the sliding bush. Cooling water jacket 18 is molded in the cylinder body. Piston 3 and piston pin 11 are the same as of the conventional engine. Connecting rod 4 is made of forged steel or hard aluminum alloy, similar to the conventional engine, only a bit smaller for the bigger end. The big end of either connecting rod is fixed into the slot of the big arm 24 on the sliding bush 14, through the pin shaft 13. The big end of the connecting rod has split structure and is installed onto the pin shaft 13 through the linkage cap 7. For ease of manufacture, the big end may also be made as the integral structure similar to the small end, with installation holes preserved on the cylinder body. Between the connecting rod and the pin shaft there is shaft shell 8 made of tin-based bearing alloy. In the connecting rod body there is lubricant hole 60. Between the small end of the connecting rod and the piston pin there is copper cover 10. Pin shaft 13 is made of 40 Cr steel and on its center there is a small hole 12. This pin shaft is transition fit with the pin hole, which is on the big arm and parallel to the central line of the main shaft. There are spring collars 42 at both ends of the pin shaft, which protrudes out of the big arm. The sliding bush 14 is made of carbonized steel or hard aluminum alloy. Two big arms 24 and two small arms 34 are symmetrically disposed on the sliding bush. The installation of connecting rods on the other big arm is in the same way. On the sliding bush, with a certain angular distance to the big arm, e.g. 90°, two small arms 34 are disposed symmetrically. Pin shaft 32, made of 40 Cr steel, is fixed on the small arm and its axis is parallel to the main shaft axis. Two detents 29, of opposite directions, are installed to the protruding ends of the pin shaft out of the sway arm, respectively. At the protruding end of the pin shaft there is spring collar 33, which is used to lock the position of the detent. At the front end of the detent there is pin 30. At the protruding end and the outer side of the spring collar, a small hole is drilled in the direction perpendicular to the pin shaft axis. A steel spring 31 is tightly fit with this hole. One end of the spring is fixed into the small hole, and the other end is pressed onto the pin shaft 30. This spring presses the detent tightly to the ratchet. Detent 29 can be made of either metallic rubber or carbonized steel. A layer of metallic rubber is welded on the tooth surface of the detent. The sliding bush 14 is turning conjugated with the main shaft 25. Between the sliding bush and the main shaft there is a bearing sleeve 15, which is made of tin-based bearing alloy. The main shaft 25 is made of 40 Cr steel, thermal refined. At the center of the main shaft there is oil cavity 64, which has oil paths 47 at the spots corresponding to all the bearings. At the front end of the bearing bracket 46 there is lubricant entry 45. Between the main shaft and the front bearing bracket there is bearing sleeve 55. Between the main shaft and the gear-ratchet module there is shaft sleeve 26. Between the main shaft and the rear bearing bracket 37 and 65 there is shaft shell 36 and 67. And there are thrust bearing rings 56 between the bearing sleeve 15 and 26, as well as between the shaft shells 36 and 67 and the big gear 39. These shaft sleeve, shaft shells and thrust bearing rings are all made of tin-based bearing alloy. Oil baffle 35 is made at the rear part of the main shaft. At the back end of the main shaft a spline 69 is made, whose shaft neck is conjugated with the rubber seal ring 68 in the flange 66. The oil cavity entry at the back end of the main shaft has internal thread and bolt socket, and the cavity is sealed by the internal hexagonal bolt 70 and copper washer 71. At the front part of the main shaft there are oil baffle 48 and sleeve 50. They are transition fit with the main shaft. Rubber seal ring 49 is installed to the main shaft hole at the front end of the cylinder body, and is fit with the main shaft sleeve 50. The oil cavity entry at the front end of the main shaft has internal thread, and the cavity is sealed by the bolt 52, pressing cap 51, and copper washers 53 and 54. An anti-clockwise ratchet 61 is set to the rear part of the main shaft. The big gear 39, made of 40 Cr steel, is installed to the rear part of the main shaft and it is fixed linked with the main shaft through the key 38. The gear-ratchet module 27, made of 40 Cr steel, is installed to the front part of the main shaft and the ratchet direction is clockwise. The intermediate gear 16, meshed with the gear-ratchet module 27 is made of 40 Cr steel and it is turning conjugated with intermediate gear shaft 17, which is fixed on the cylinder body. The root section of the intermediate gear shaft is trapezoid. At one end of the intermediate gear there are two holed ears. A horizontal coattail slot, which is fit with the root section of the intermediate gear, is made on the bearing bracket 46. The shaft root of the intermediate gear is inserted into this slot and clearance is preserved at the bottom of the slot. Intermediate gear shaft 17 is fixed to the bearing bracket 46 with bolt. Between the ear of the intermediate gear shaft and the fitting surface of the bearing bracket there is copper gasket 77, which is used to adjust the fitting clearances with gears about to the intermediate gear. In the bearing bracket 46 and the intermediate gear shaft there are lubricant paths 75 and 76. Between the intermediate gear and its shaft is the bearing sleeve 72, made of tin-based bearing alloy. The axial position of the intermediate gear is defined by the bolt 74 and the shield ring 73. The small gear 21, meshed with the intermediate gear, is made of 40 Cr steel and is fixed fit with the transmission shaft 23 through the key 19. The transmission shaft 23 is made of 40 Cr steel. At its other end there is a big gear 22, made of 40 Cr steel, fixed to it through the key 19. It meshes with the big gear 39 on the main shaft. Bearing sleeves 58 and 62, made of tin-based bearing alloy, are mounted to both ends of the transmission shaft and they are respectively fixed into the bearing brackets 57 and 63, which are made of carbonized steel. The cross section of the bearing brackets 57 and 63 is rectangle and they have two holed ears. They are fixed through bolts in the vertical slots of the bearing brackets 46 and 65, which fit with them. At the bottom of the slots there is clearance preserved. Between the ears of the bearing brackets 57 and 63 and the fitting surfaces of the bearing brackets 46 and 65 there are copper gaskets 77, which are used to adjust the fitting clearances between conjugated gears. Under the cylinder body cap 9, which is made of the carbonized steel plate, there are two fixture plates 6, which are made of carbonized steel. The two fixture plates are placed to both sides of the big arm of the sliding bush. On both plates, at the points corresponding to the perpendicular lines for the left and right stop points of the central holes 12 of the pin shaft 13 on the big arm, two deep blind holes are drilled. On both plates, at the points corresponding to the left and right stop points of the central holes 12 of the pin shaft 13 on the big arm, two small holes 41 and 43, coaxial to the central hole 12, are drilled and they are connected to the corresponding deep blind holes, respectively. Two emitting photoelectric cells 40 with their wires are inserted into the two blind holes of the fixture plate on the right side of the arm, respectively. The heads of the cells are located in the small hole 41. The wires are connected to the concentrative electronic controller via the connector 5, which is fixed to the upper end of the deep blind hole. Two receiving photoelectric cells 44 with their wires are inserted into the two blind holes of the fixture plate on the left side of the arm, respectively. The heads of the cells are located in the small hole 43. The wires are connected to the concentrative electronic controller via the connector 5, which is fixed to the upper end of the deep blind hole. At the bottom of the cylinder body there is a drain pan 20. The suction filter 29 is set in the drain pan and is connected to the engine oil pump via pipe path. The filter recycles the engine oil. The cylinder cap and valve control mechanism of the engine is the same as in the patent with application number 200510091222.X in China.

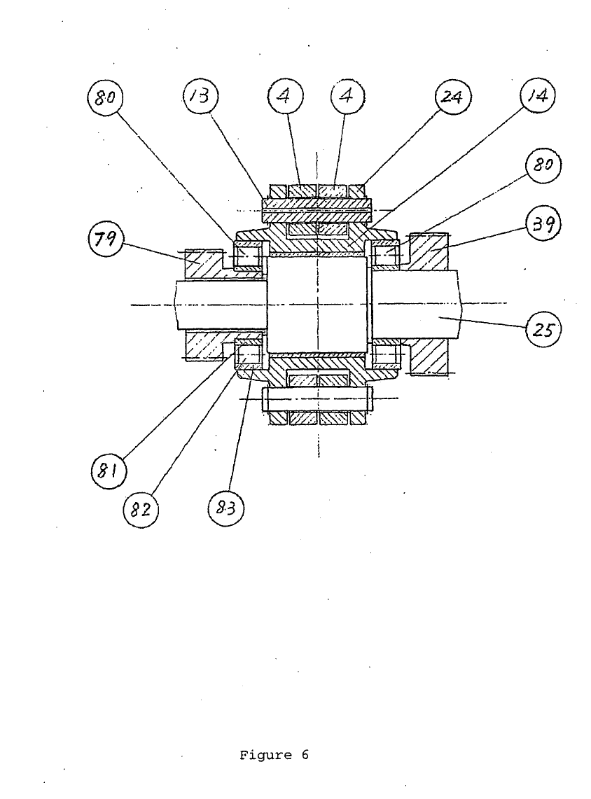

If the nominal rotation speed of the engine is not very high, the detent 29, ratchet gear 61 and the ratchet gear of the gear-ratchet module 27 can together be replaced by a non-return stopper 80 with unidirectional driving function. This non-return stopper is one of the overrun clutches and its structure can be found in existing technology. As shown in FIG. 6, this stopper consists of inner ring 81, outer ring 83 and irregular block 82. The installation direction of the irregular block 82 defines the unidirectional driving direction of the stopper. The stoppers installed on both sides of the sliding bush 14 have opposite directions. The outer ring 83 is fixed fit with the sliding bush 14. The inner ring 81 of the left stopper is fixed fit with the cam shoulder of the small gear 79 (in place of the gear-ratchet module 27). The inner ring 81 of the right stopper is fixed fit with the main shaft 25. Such structure has the same function as the detent of the ratchet.

Concerning the overall layout requirement of the engine, the cylinders in this patent can also be disposed vertically or in V-shape. The forces upon the sliding bush from the pistons on both sides of the main shaft, and from the connecting rods make the sliding bush rotate in both directions. In order to reduce the interference among the layout of the cylinders inside the body, the sliding bush should be broader and the distance between the two big arms, which are connected to the connecting rods, should also be larger.

The operation process of the engine in this patent is as followed.

For better understanding, we name the four cylinders E, F, G and H, anti-clockwise, up to down, left to right. Assume the state in FIG. 1 is that cylinder E is in the end of compression, F in the end of intake, G in the end of exhaust, and H in the end of power, when the central hole 12 of the pin shaft 13 on the big arm of the sliding bush is exactly at the left stop point A, and the central hole 12 is exactly coaxial with the small holes 41 and 43 on the two fixture plates. The light out of the emitting photoelectric cell 40 is received by the receiving photoelectric cell 44, and then, is converted into electric signals, which are sent to the concentrative electronic controller. After processing, the micro computer identifies that the cylinder E is at the state of the beginning of power stroke and sends commands to the injection system and the ignition system, so that the injector injects fuel, and the igniter ignites in cylinder E. The computer also sends out commands to the components of other cylinders according to programs. In cylinder F, all the valves are closed; in cylinder G, the intake valve is closed and the exhaust valve is opened; in cylinder H, the exhaust valve is opened and the intake valve is closed. At this time cylinder E starts the power stroke, cylinder F starts the compression stroke, cylinder G starts the intake stroke and cylinder H starts the exhaust stroke. Meanwhile, pushed by the piston linkage of cylinder E, the sliding bush rotates clockwise, and the other linkage on the same pin shaft pushes the piston in cylinder H to the right. The big arm on the other end of the sliding bush pushes the piston in cylinder F to the left through the linkage, and at the same time pulls the linkage as well as the piston in cylinder G to the left. The two clockwise detents 29 on the small arm 34 on the sliding bush are meshed with the ratchet teeth 28 on the gear-ratchet module 27, and rotate this module clockwise. Through the intermediate gear 16, the gear in the gear-ratchet module 27 then rotates the small gear 21 and the big gear 22 on the transmission shaft 23 clockwise. The big gear 22 is meshed with the big gear 39 on the main shaft and rotates the main shaft anti-clockwise. When the central hole 12 on the pin shaft of the big arm goes to the right stop point D, it is coaxial to the small holes 41 and 43 corresponding to the other pair of photoelectric cells. The light out of the emitting photoelectric cell 40 is received by the receiving photoelectric cell 44, and then, is converted into electric signals, which are sent to the concentrative electronic controller. After processing, the micro computer identifies that the cylinder F is at the state of the beginning of power stroke and sends commands to all the cylinders, so that cylinder F starts the power stroke and the sliding bush is rotated anti-clockwise. And the linkage in cylinder F pushes the piston in cylinder G to the right, thus cylinder G starts the compression stroke. Pushed by the other arm and linkage, the piston in cylinder E goes left and starts exhaust stroke, as well as pulls the linkage and piston in cylinder H left, starting the intake stroke for cylinder H. At the same time, the other pair of detents, fixed on the small arm, are meshed with the ratchet teeth of the anti-clockwise ratchet gear 61, fixed on the main shaft, and make the main shaft rotate anti-clockwise. The big gear 39, fixed on the main shaft, makes the gear-ratchet module rotate clockwise, through the gear and the intermediate gear on the transmission shaft. Because the direction of the gear-ratchet module is opposite to that of the sliding bush, the ratchet on it races against the corresponding detents. The operation processes for all cylinders can be numerated as foregoing, FIG. 1 as the starting state:

Cylinder E: power, exhaust, intake, compression.
Cylinder F: compression, power, exhaust, intake.
Cylinder G: intake, compression, power, exhaust.
Cylinder H: exhaust, intake, compression, power.
Every cylinder repeats the stroke cycles as above. Except the sliding bush, every gear rotates always in a fixed direction. Two sets of ratchet gears, of opposite directions, work one after the other and drive the main shaft rotate always in one direction.

1. A driving mechanism with toggle rods and ratchet wheels for a crankless engine, in which at least two cylinders (2) are set in the cylinder body (1), characterized in that this driving mechanism composes of a main shaft (25) with sliding bush (14); The sliding bush (14) and the main shaft (25) are coaxial and turning conjugated; The main shaft (25) is set among the cylinders and its axis is perpendicular to, but does not intersect, the axes of the cylinders; On the sliding bush there are big arms (24) and small arms (34); The piston linkage in the cylinder (2) is connected to the big arm (24) via a pin (13); The force direction of the piston linkage is tangential to, or tangential with a small deviation to the rotation arc of the pin center of the big arm around the main shaft center; The driving directions of the two piston linkages upon the main shaft are opposite to each other, and the reciprocate motions of the pistons drive the big arm (24) sway left and right; The ratchet detent (29) is mounted on the small arm (34) and this detent (29) pokes the ratchet wheel (61) combined with the main shaft (25) and drives the main shaft (25) rotate unidirectionally, while the big arm (24) is swaying left and right.

2. The driving mechanism according to claim 1, characterized in that the number of cylinders (2) is four and they are disposed horizontally and divided into two groups, the upper group and the lower group; In each group, the pair cylinders are disposed opposite to each other and there is a certain distance between the two group axes; On the sliding bush there are two big arms (24) and two small arms (34) and they are set symmetrically with an angular distance; On the big arms (24) there are a slot parallel to the cylinder (2) axis and a pin hole parallel to the main shaft (25) axis; The pin (13) is put into the pin hole; The larger head of the connecting rod connected to the piston in the cylinder (2) is set in the slot on the big arm (24) and is turning conjugated with the pin shaft (13); A pin shaft (32) is set on the small arm (34) and its axis is parallel to the main shaft (25); In either side of the pin shaft (32), which protrudes the small arm (34), two ratchet wheels (29) of opposite directions are mounted.

3. The driving mechanism according to claim 2, characterized in that at the rear part of the main shaft an anti-clockwise ratchet wheel (61) is made; A big gear (39) is fixed to the rear part of the main shaft near this ratchet wheel (61); At the front part of main shaft a gear-ratchet module (27) is mounted and this module is turning conjugated with the main shaft and the ratchet rotation direction is clockwise; The clockwise ratchet detent (29) mounted onto the small arm (34) of the sliding bush meshes the ratchet teeth (28) of the gear-ratchet module (27); And the anti-clockwise ratchet detent (29) meshes the anti-clockwise ratchet wheel (61); While the big arm (24) rotates anti-clockwise, the anti-clockwise ratchet detent pokes the anti-clockwise ratchet wheel (61) combined with the main shaft (25) and drives the main shaft (25) rotate anti-clockwise. While the big arm (24) rotates clockwise, the clockwise ratchet detent pokes the gear-ratchet module (27) to rotate clockwise as well as to drive the main shaft (25) rotating anti-clockwise via the intermediate gear, transmission shaft and the big gear on the main shaft.

4. The driving mechanism according to claim 3, characterized in that the pin (30) is mounted to the front part of the ratchet detent (29); A small hole is made on the pin shaft in the direction perpendicular to the pin shaft; A spring of steel wire (31) is tightly conjugated to this hole, one end is fixed in the small hole, another end is pressed to the pin (30).

5. The driving mechanism according to claim 3, characterized in that the intermediate gear (16) meshed with the gear-ratchet module (27) is turning conjugated with the intermediate gear shaft (17) mounted on the bearing bracket (46); The root of the intermediate gear is a trapezoid; At one end of the intermediate gear shaft two holed ears are set; On the bearing bracket (46) there is a horizontal coattail slot meshed to the root of the intermediate gear and the root of the intermediate gear shaft is inserted into this slot; At the bottom of the slot a clearance is reserved, the intermediate gear shaft (17) is fixed on the bearing bracket (46) with bolt and pin; Between the ear of the intermediate gear shaft and the meshing surface of the bearing bracket the adjusting padding (77) is added; The small gear (21) meshed with intermediate gear is turning conjugated with the transmission shaft (23); The transmission shaft is parallel to the main shaft; The modulus of the gear of the gear-ratchet module (27) is the equal to that of the intermediate gear (16) and that of the small gear; The diameter of the gear of the gear-ratchet module (27) is equal to that of the pitch circle of the small gear (21); A big gear (22) is fixed conjugated to the other end of the transmission shaft (23) and its modulus and pitch circle diameter are the same as those of the big gear (39) fixed on the main shaft, and it is also directly meshed to the big gear (39); Sliding bearing sleeves (58) and (62) are assembled on both sides of the transmission shaft (23) and they are respectively fixed on the bearing brackets (57) and (63); Bearing brackets (57) and (63) have rectangle section and holed ears, which is fixed through bolts to the meshing slots of the bearing brackets (46) and (65); At the bottom of the slot a clearance is reserved; Between the ears of the bearing brackets (57) and (63) and the meshing surface of the bearing brackets (46) and (65) the adjusting padding (77) is added; The bearings of the entire rotating components are sliding bearings, pressure lubricated.

6. The driving mechanism according to claim 1, characterized in that a central hole (12) is made on the pin shaft (13) of the big arm (24); Emitting photoelectric cell (40) and receiving photoelectric cell (44) are set on the axis of the pin shaft central hole (12) at the left and right stop points for the big arm (24) sway; These cells are disposed on both sides of the big arm of the sliding sleeve and connected to a concentrative electronic controller.

7. The driving mechanism according to claim 6, characterized in that two fixture plates (6) are fixed beneath the coping (9) of the cylinder (1) and these two plates are mounted to both sides of the big arm of the sliding sleeve; two deep blind holes are drilled on both plates at the positions corresponding to the points perpendicular to the left and right stop points of the central hole (12) of the pin shaft (13) on the big arm; Two small holes (41) and (43), coaxial to the pin shaft central holes, are drilled on both plates at the positions corresponding to the left and right stop points of the central hole (12) of the pin shaft (13) on the big arm and these two small holes are connected to their corresponding deep blind holes; Two emitting photoelectric cells (40) with their wires are inserted into the two deep blind holes of the fixture plate right to the swaying arm and their heads are located in the small holes (41), and their wires are connected to the concentrative electronic controller; Two receiving photoelectric cells (44) with their wires are inserted into the two deep blind holes of the fixture plate left to the swaying arm and their heads are located in the small holes (43), and their wires are connected to the concentrative electronic controller.

8. The driving mechanism according to claim 1, characterized in that the material of the ratchet detents is metallic rubber, or carbon steel with a layer of metallic rubber brazed onto the surface.

9. The driving mechanism according to claim 3, characterized in that the ratchet detent (29), ratchet wheel (61) and the ratchet wheel of the gear-ratchet module (27) are replaced by a non-return stopper that has the function of driving unidirectionally; This stopper consists of inner ring (81), outer ring (83) and a block (82) of irregular shape; The driving directions of the non-return stoppers on both sides are opposite to each other; The outer ring of the stopper is fixed conjugated with the sliding sleeve; The inner ring of the left stopper is fixed conjugated with the cam shoulder of the small gear; The inner ring of the right stopper is fixed conjugated with the main shaft.

10. The driving mechanism according to claim 1, characterized in that two or two groups of cylinders are disposed vertically or disposed in V-shape to the two sides of the main shaft respectively.
